(19) United States
(12) Patent Application Publication
(10) Pub. No.: US 2003/0069948 A1
(43) Pub. Date: Apr. 10, 2003

(54) Automated online subscription

(76) Inventors: Donghai Ma, Acton, MA (US); Ajit Nair, Framingham, MA (US); Craig Boyle, Auburn, MA (US); Eric James Gieseke, Lincoln, MA (US); Jyotirmoy Sarkar, Westford, MA (US); Tavit Ohanian, Waltham, MA (US)

Correspondence Address: LEFFERT JAY & POLGLAZE, P.A., P.O. BOX 581009, MINNEAPOLIS, MN, 55458-1009, US

(21) Appl. No.: 09/972,826

(22) Filed: Oct. 5, 2001

(51) Int. Cl. G06F 15/177

(52) U.S. Cl. 709/220; 709/219

(57) ABSTRACT

An automated registration process for registering a new user and new high speed access device with an internet service provider is accomplished without requiring user input aside from choices of service provider, service level agreement, and the provision of basic user information. A mediation server communicates with a provisioning server to obtain necessary access device information without requiring a user to access or know such information.

The present invention relates generally to assignment of users to an internet service provider, and more specifically to automated assignment.

### BACKGROUND

The Internet, a global computer network on which hundreds of millions of users perform any number of tasks, such as the sending and receiving of electronic mail (E-mail), file transfer, interactive video, information retrieval and storage, business transactions, video conferencing, and the like, is fast becoming a staple of society. Access to the Internet is accomplished through an internet service provider (ISP). The ISP sells its services as a provider to individual users and groups, who connect to the ISP via a communications access device. Such devices include but are not limited to dialup modems, cable modems, digital subscriber loop (DSL) modems, media termination adapters (MTAs), and direct lines such as T1 and T3 lines.

Typically, a user sill sign up or register with a service provider. Some service providers place software on new computer systems that will access the service, and will walk a user through a new connection with a dialup modem. However, configuring users of higher speed and dedicated devices such as cable modems, DSL modems and the like is more difficult.

Typically, in a cable modem configuration, such information as the media access control (MAC) address of the cable modem and other configuration information are required in order to configure the cable modem. The MAC address is a unique address identifier for devices such as cable modems, network interface cards, and the like. Cable modem identification and configuration is traditionally performed the first time by a technician who physically goes to the location where the cable modem is to be deployed, and who identifies the relevant information for initial configuration of the cable modem. The typical required information is often beyond the scope of knowledge of inexperienced computer users, and is pertinent for proper provisioning and configuration of the cable modem. Installations by technicians require appointments, and due to the increasing demand for high speed access to the Internet, wait times for installation and initial configuration of high speed access devices such as cable modems may be weeks or more.

There is therefore a need in the art for a more automated initial configuration of high speed access devices for connection to an ISP.

### SUMMARY

In one embodiment, a method for automated registration of a new user to an internet service provider includes assigning a user access device an IP address and a default profile, and assigning a computer connected to the user access device a default non-ISP IP address. The user signs up for an ISP at a service level. The user access device is reprovisioned with a new configuration file for the chosen ISP, the computer is assigned a new IP address within a range of addresses for the chosen ISP.

In another embodiment, a method of operating a mediation server includes receiving a request for access to an ISP, determining an IP address of the request, associating the IP address with an access device MAC address, and reconfiguring the access device for the ISP.

In yet another embodiment, a method of operating a provisioning system includes assigning an IP address to a new access device, storing a MAC address of the new access device in a directory server, providing the MAC address associated with the IP address when requested by an external mediation server, and creating an access device configuration file for ISP information provided by the mediation server.

In still another embodiment, a provisioning system includes a dynamic host configuration protocol server, a trivial file transfer protocol server, and a computer program resident and operating on the DHCP server. The program executes a method including assigning an IP address to a new access device, storing a MAC address of the new access device in a directory server, providing the MAC address associated with the IP address when requested by an external mediation server, and creating an access device configuration file for ISP information provided by the mediation server.

In another embodiment, an automated registration system includes a directory server, a mediation server, and a provisioning server. The mediation server has a computer program for receiving a request for access to an ISP, determining an IP address of the request, associating the IP address with an access device MAC address, and reconfiguring the access device for the ISP. The provisioning server has a computer program for assigning an IP address to a new access device, storing a MAC address of the new access device in the directory server, providing the MAC address associated with the IP address when requested by the external mediation server, and creating an access device configuration file for ISP information provided by the mediation server.

Other embodiments are described and claimed.

### BRIEF DESCRIPTION OF THE DRAWINGS

FIG. 1 is a block diagram of a communications system according to one embodiment of the present invention;

FIG. 2 is a block diagram of a network on which embodiments of the present invention are practiced;

FIG. 3 is a message flow diagram according to one embodiment of the present invention;

FIG. 4 is a message flow diagram according to another embodiment of the present invention;

FIG. 5 is a message flow diagram according to still another embodiment of the present invention;

FIG. 6 is a message flow diagram according to yet another embodiment of the present invention; and

FIG. 7 is a message flow diagram according to still yet another embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

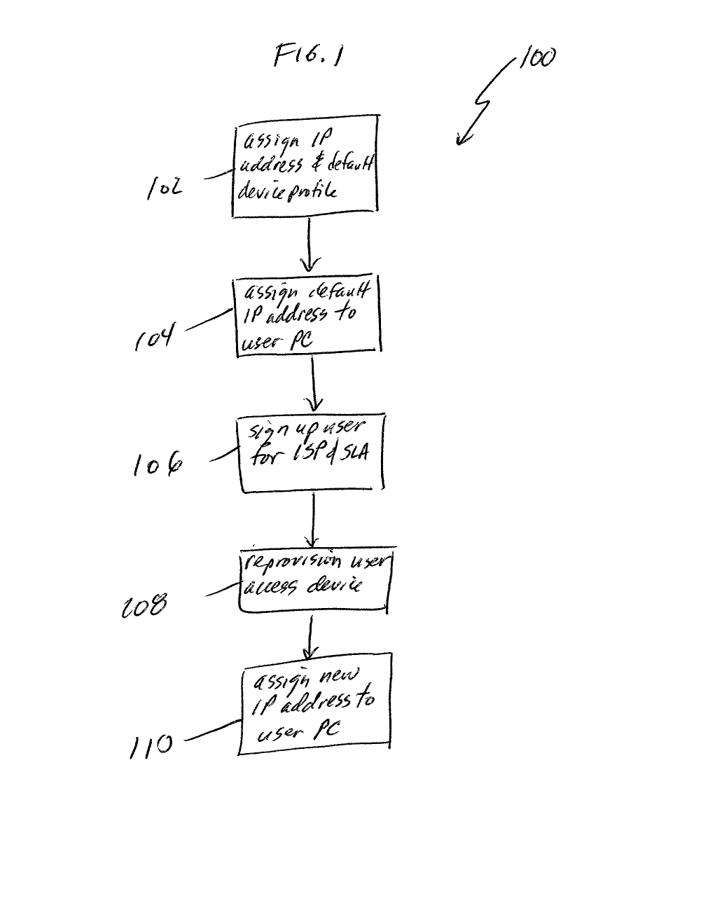

FIG. 1 is a flow chart diagram of a method 100 for automated registration of a new user to an internet service provider (ISP). Method 100 comprises assigning an internet protocol (IP) address and a default access device profile to a user access device when the access device is first connected to a user computer and turned on in block 102. Examples of user access devices include by way of example only and not by way of limitation, cable modems, DSL modems, wireless modems, and the like. In one embodiment, user access devices comprise a group of access devices that require configuration files to be initialized, or provisioned. In block 104, the computer connected to the user access device is assigned a default IP address outside the range of a number of ISPs that have IP address ranges.

In block 106, the user signs up for an ISP by providing information about billing and the like, and by choosing one of a number of available ISPs and service level agreements (SLAs) within the chosen ISP. This is in one embodiment accomplished using a mediation server to which the user access device is directed before true access to the internet is allowed. In essence, it forces the user to register with an ISP before accessing the internet. In block 108, the user access device is reprovisioned according to the ISP and SLA the user has chosen. The user computer is assigned a new IP address within the range of IP addresses of the user's chosen ISP in block 110. Further detail of each of the process blocks of method 100 is provided below.

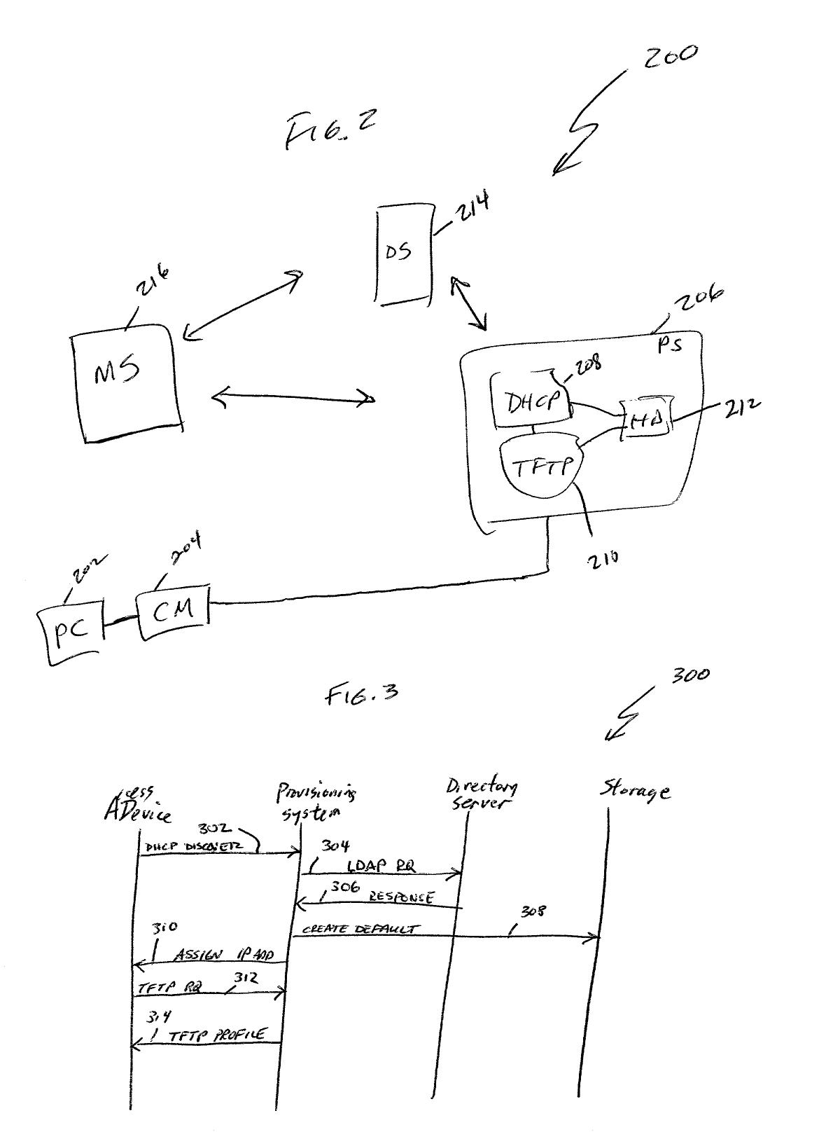

FIG. 2 is a block diagram of a computer network 200 having components accessed or used during process flow of the method 100. Computer network 200 comprises a user PC 202, a user access device 204 such as a cable modem (CM) or the like connected to the computer 202 and to a provisioning system 206. Provisioning system 206 comprises in one embodiment a dynamic host configuration protocol (DHCP) server 207, a trivial file transfer protocol (TFTP) server 210, system log (SYSLOG) and time of day servers (not shown), and some sort of storage 212 such as a hard drive or the like. In various embodiments, the provisioning system is a single computer functioning as all of the elements, and in other embodiments, the provisioning system is multiple computers connected together to function as a provisioning system.

A directory server 214 storing configuration information for access devices as well as information pertaining to service levels and ISPs available to users of the provisioning system and a mediation server 216 that operates a front end web server for signup to various ISPs are in communicative contact with each other and with the provisioning system. The communicative connection is in one embodiment accomplished via simple network management protocol (SNMP).

FIG. 3 is a message flow diagram 300 for a process of assigning an internet protocol address to a new access device the first time it is powered up. A user who wishes to access a network such as network 200 and ultimately the internet or the world wide web using a high speed access device such as a cable modem, DSL modem, wireless modem or the like obtains the device, and connects the device to a user supplied computer such as computer 202 and to a device access port such as a cable box, cable connection, DSL line connection or the like. The connection to a device access port connects the device to a provisioning system such as provisioning system 206.

The first process upon power up of a new access device is that when a user first turns the connected access device on, the device powers up and sends a request (302) to a dynamic host configuration protocol (DHCP) server of the provisioning system for configuration information. The DHCP discover request contains the MAC address of the access device, which is known to the device. The provisioning system DHCP server sends a lightweight directory access protocol (LDAP) request (304) to a directory server to look up the received MAC address in a directory server database. If the MAC address does not exist in the directory server database, and it will not exist for a new access device, a directory server response is sent (306) with instructions to use a default profile for the type of access device requesting access. The provisioning system DHCP server creates a default configuration file for the access device and stores it (308) in mass storage, locally or on another external HD. The access device is assigned an IP address (310). The access device then sends a TFTP request (312) for a configuration file to a TFTP server in the provisioning system. The default configuration file or profile information for the default access device profile is transferred to the access device via TFTP (314). At this point, the access device MAC address is known to the provisioning system.

Filters set in the access device by the default profile assign a low priority low bandwidth class of service to the device, since the user has yet to subscribe to an ISP. The configured internal device filters allow access hyper text transfer protocol (HTTP) access only to an ISP provisioning web site, in one embodiment hosted by a mediation server.

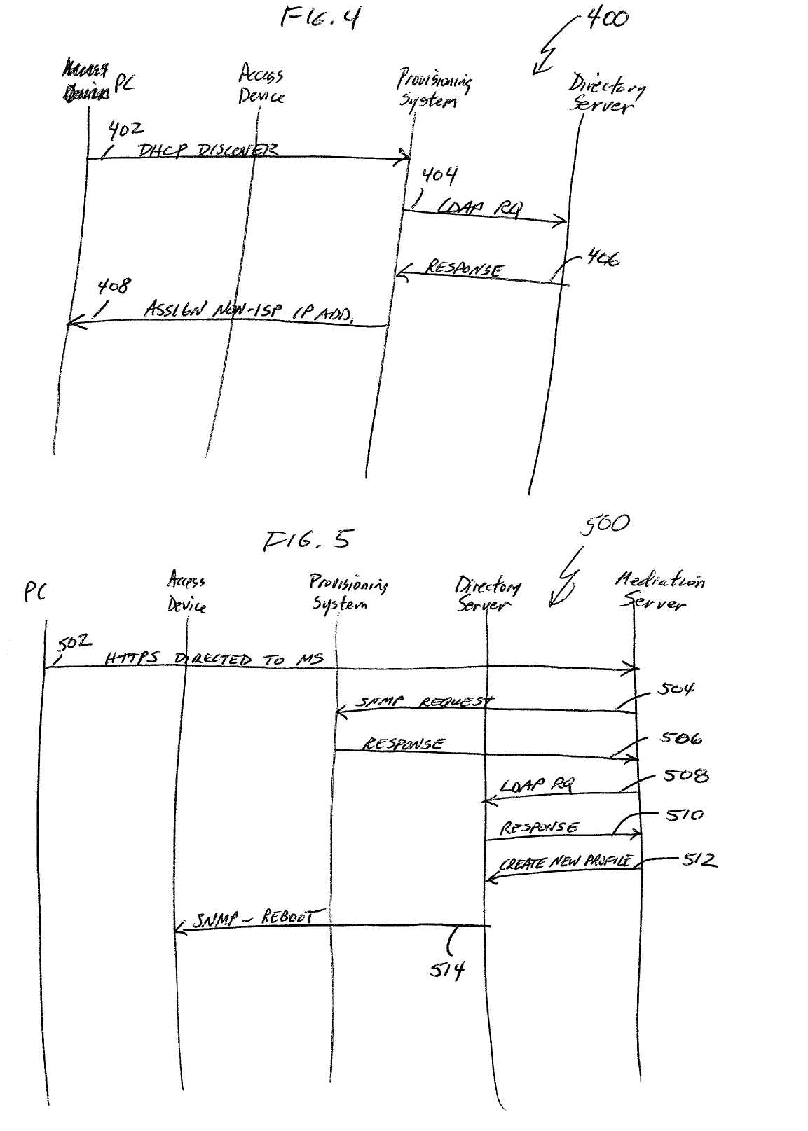

FIG. 4 is a message flow diagram of a process 400 for assigning a computer connected to the user access device a default non-ISP IP address. A non-ISP IP address is an IP address that is not within any range of IP addresses owned or leased by a particular ISP as addresses that the particular ISP assigns to its subscribers. The filters configured in the process flow of FIG. 3 limit access of the user's PC to an ISP provisioning web site. This web site is in one embodiment hosted by a provisioning system such as provisioning system 206 described above. In the process 400, the user PC sends a DHCP discover request which is directed through the access device and its filters to the provisioning system web site on the provisioning system (402). The request contains the MAC address and assigned IP address of the access device, the IP address which has been assigned in initial communications described above with respect to FIG. 3.

The DHCP server within the provisioning system knows the access device IP address from which the computer is making the request, and that IP address is identified with the MAC address of the access device. An LDAP request to the directory server (404) asks whether the particular access device MAC address is assigned to an ISP. At this point in the process for a new access device, the MAC address is unassigned to an ISP. The response (406) from the directory server to the provisioning system DHCP server is that the access device MAC address is not assigned to an ISP. A non-ISP IP address for the PC is selected, and is assigned to the PC (408). This IP address identifies an unregistered user.

FIG. 5 is a message flow diagram of a process 500 for signing a user up for an ISP at a service level offered by the ISP. This is accomplished through interaction in one embodiment with a mediation server such as mediation server 216 described above. The mediation server in one embodiment hosts a web site for allowing a user to choose an ISP and a service level agreement for the ISP from one of potentially multiple ISPs that offer service subscription through the mediation server.

Once the PC has a non-ISP IP address, PC access to the internet is restricted via the non-ISP limitation of the address to access to the mediation server web server front end, where registration for an ISP occurs. When the user accesses the mediation server web site (502), the non-ISP IP address of the PC is obtained. At this point, the mediation server only knows the IP address of the user PC. However, the mediation server needs the MAC address of the access device to obtain from a directory server such as directory server 214 described above information pertaining to the ISPs and services available to the specific type of access device the user is using.

A request is sent via SNMP (504) to a provisioning server with a request for the MAC address and IP address of the access device associated with the PC IP address. Since the access device has previously communicated with the provisioning system, such as in the process flow of FIG. 3, this information is known at the provisioning system. The requested information is transmitted (506) to the mediation server. In other words, the PC IP address that is obtained by the mediation server is transferred to the provisioning system, and the PC IP address is looked up in the provisioning system to obtain its corresponding access device MAC address and IP address.

Once the access device MAC address and IP address are transferred to the mediation server, the mediation server queries a directory server (508) for the ISPs and services available for the particular access device whose MAC address and IP address have been obtained from the provisioning system. The directory server looks up the available ISPs and services available within those ISPs for the particular access device. There are in one embodiment multiple ISPs and SLAs to choose from. The services and ISPs available for the particular access device are transferred (510) to the mediation server. The user chooses an ISP and service level from the available choices.

Once the choice of ISP and service level is made, and the user completes the registration with the ISP by providing payment and other relevant user information to the mediation server, the mediation server sends an LDAP request to the directory server (512) to create a new access device configuration profile for the particular ISP and service level chosen by the user. The mediation server then sends an SNMP command (514) to the access device with the configuration file or configuration information and a command to reboot using the new configuration file.

At this point, the access device has an assigned IP address, a MAC address, and an access device profile with a known class of service. The user's PC still has a non-ISP IP address.

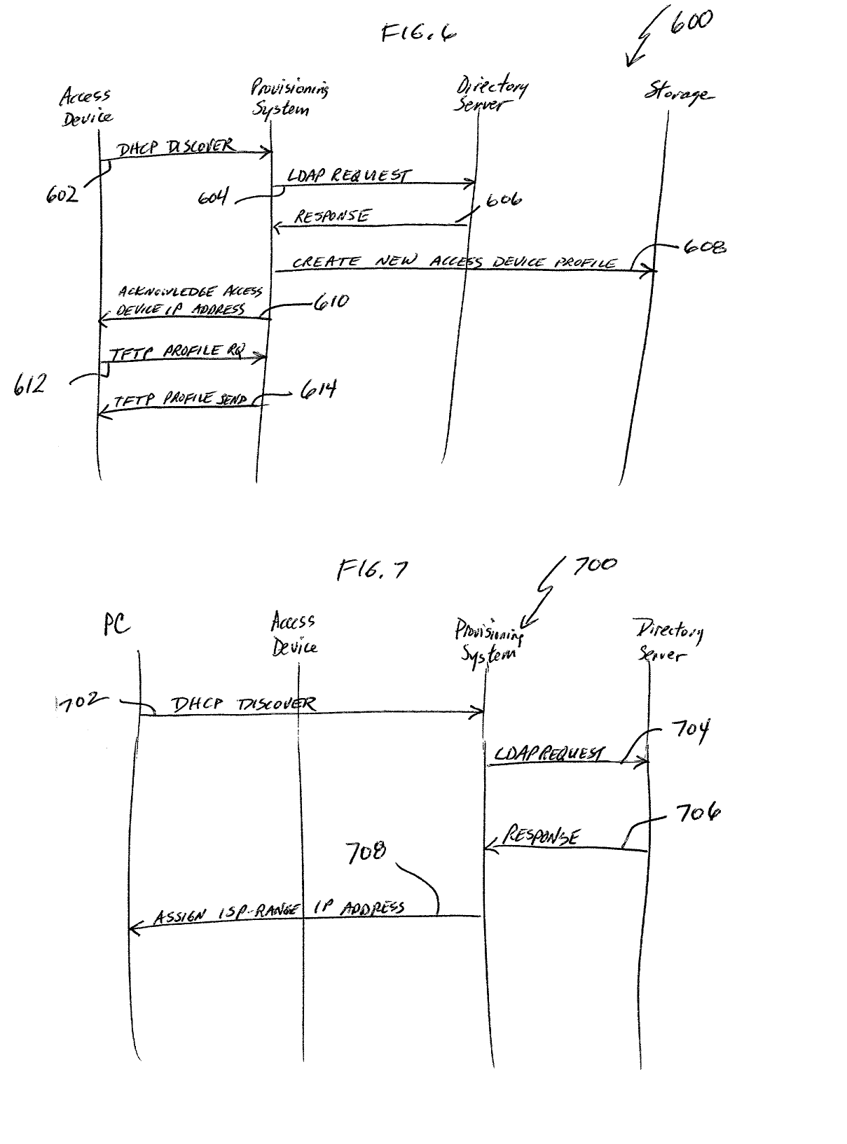

FIG. 6 is a message flow diagram of a process 600 for reprovisioning the user access device with a new configuration file for the chosen ISP. Once the access device has rebooted, the access device sends a DHCP discover request (602) to the provisioning system DHCP server. This request contains the access device MAC address and default non-subscriber information from the access device configuration profile obtained at the mediation server as described above with respect to FIG. 5. The DHCP server sends an LDAP request (604) to the directory server asking if the access device MAC address is valid, that is if the MAC address exists in the directory server database. The LDAP request also contains a request for an identification of the ISP and service level for the configuration profile from the access device, and requesting a correct access device profile.

The directory server looks up the MAC address, to find whether the MAC address exists in the database. For a new subscriber, at this point the MAC address is in the database. The directory server sends an acknowledgement (606) that the access device MAC address is in the database, and identifies the ISP and associated information for the access device. A new access device configuration file is generated (608) with the specific ISP and SLA information. This configuration file is stored locally at the provisioning server. An acknowledgement (610) that the access device retains its IP address is sent to the access device. The access device then sends a TFTP profile request (612) for a final new configuration profile to a TFTP server within the provisioning system. The configuration file is retrieved from the PS hard drive or other mass storage, and the profile is sent via TFTP (614) to the access device. The access device now has the correct profile for its user PC ISP and SLA within the ISP.

The user is ready to access the internet via the ISP at the chosen service level. However, the user PC still has a non-ISP IP address. FIG. 7 is a message flow diagram of a process 700 for assigning the user PC a new IP address within a range of addresses for the chosen ISP. The first time the user wishes to access the internet under the new ISP and SLA, the user's PC sends a DHCP discover request (702) through the newly configured access device to the provisioning system DHCP server. The DHCP server makes an LDAP request (704) to the directory server with the access device information and the PC IP address previously assigned. The LDAP request asks if the PC IP address is assigned to the ISP identified with the MAC address and profile information of the access device. The directory server looks up the desired information in its database, and acknowledges (706) that the MAC address is assigned to an ISP, along with the specific ISP and SLA information, and instructs the provisioning system to assign a new PC IP address within the range of IP addresses associated with the chosen ISP. The provisioning system DHCP server sends a new PC IP address (708) within the range of IP addresses of the chosen ISP to the user's PC.

The user is then ready to access the Internet, and the user's access device is fully provisioned for the ISP and SLA within the ISP without any direct action required from the user with the exception of choosing an ISP and SLA within that ISP, and providing payment and contact information. No knowledge of the internal operation or parameters of the access device or PC are required.

The automated processes for registering a new access device and new user to an ISP with a chosen SLA reduce the likelihood of common errors, such as improper entrance of a MAC address by a user or technician. Accordingly, the processes reduce the need for staffing of support lines, and for increased support budgets. The automation processes allow a user to register a new access device on the user's own schedule, and do not subject the user to potentially long delays between the desire to register with an ISP and actual registration of a high speed access device.

The methods shown in FIG. 1 and the processes of the message flow of FIGS. 3, 4, 5, 6, and 7 may be implemented in whole or in part in various embodiments in a machine readable medium comprising machine readable instructions for causing a system such as the provisioning system or the mediation server shown in FIG. 2 to perform the methods. The computer programs run on a central processing unit of the system out of main memory, and may be transferred to main memory from permanent storage via disk drive or CD-ROM drive when stored on removable media or via a network connection or modem connection when stored outside of the computer, or via other types of computer or machine readable media from which it can be read and utilized.

Such machine readable media may include software modules and computer programs. The computer programs may comprise multiple modules or objects to perform the methods in FIG. 1 or the processes of the message flows of FIGS. 3, 4, 5, 6 and 7 or the functions of various apparatuses of FIG. 2. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

The embodiments of the invention provide for mediation and communication between a mediation server and a provisioning server. The mediation server uses information it knows about a user PC to obtain configuration information and available ISP information for a high speed access device connected to the user PC. The interface between the mediation server and the provisioning server is through open access protocols SNMP to allow the mediation server to communicate with a provisioning server and obtain the MAC address and IP address of an access device or other customer provided equipment that is requesting a change of service or a new service. The mediation between the mediation server and the provisioning server allows the embodiments of the invention to perform registration of a user to an ISP without the need for the user to have specific knowledge of the workings and specifications of the specific access device the user utilizes to access the ISP.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for automated registration of a new user to an internet service provider, comprising:
assigning a user access device an IP address and a default profile;
assigning a computer connected to the user access device a default non-ISP IP address;
signing a user up for an ISP at a service level;
reprovisioning the user access device with a new configuration file for the chosen ISP; and
assigning the computer a new IP address within a range of addresses for the chosen ISP.

2. The method of claim 1, wherein assigning a user access device an IP address and a default profile comprises:
requesting configuration information for the access device from a provisioning system;
checking if a MAC address of the access device is registered with a directory server; and
assigning a default profile and IP address to the access device if the MAC address is not registered.

3. The method of claim 2, wherein assigning a default profile comprises:
creating a default configuration file for the access device; and
storing the default configuration file in a mass storage.

4. The method of claim 3, and further comprising:
transferring the default configuration file to the access device via TFTP.

5. The method of claim 1, and further comprising:
setting filters in the access device to direct any hypertext transfer protocol request to an ISP provisioning site.

6. The method of claim 1, wherein assigning a computer connected to the user access device a default non-ISP IP address comprises:
directing any http request from the access device to an ISP provisioning site.

7. The method of claim 1, wherein assigning a computer connected to the user access device a default non-ISP IP address comprises:
sending a DHCP request to a provisioning web site with an assigned IP address of the access device;
requesting an ISP assignment of the IP address of the access device from a directory server;
selecting a non-ISP IP address not assigned to a specific ISP; and
communicating the non-ISP IP address to the access device.

8. The method of claim 1, wherein signing a user up for an ISP comprises:
communicating an assigned user computer IP address to a mediation server;
communicating with a provisioning server to obtain an access device MAC address and access device IP address corresponding to the user computer IP address;
retrieving a list of ISPs and services available for the particular access device whose MAC address and IP address have been obtained;
subscribing a user to one of the retrieved available ISPs;
creating a new access device configuration profile for the subscribed to ISP; and
rebooting the access device with the new configuration profile.

9. The method of claim 8, wherein rebooting the access device comprises:
issuing an SNMP command to the access device to reboot with the new configuration profile.

10. The method of claim 1, wherein reprovisioning the user access device comprises:
sending a DHCP request to a provisioning server with an ISP specific configuration profile;
retrieving an ISP specific configuration profile from a directory server;
creating a new configuration file at the provisioning server; and
transmitting the new configuration file to the access device.

11. The method of claim 10, wherein the new configuration profile is retrieved via TFTP.

12. The method of claim 1, wherein assigning the computer a new IP address comprises:
sending a DHCP request from the user computer through an ISP configured access device;
selecting a new IP address within a range of IP addresses of the user ISP; and
transmitting the new IP address to the user computer.

13. The method of claim 1, wherein the user access device is a cable modem.

14. A method for provisioning a cable modem connected to a computer, comprising:
assigning the cable modem an initial IP address and a default profile generated by a provisioning system;
assigning the computer a default non-ISP IP address;
determining a user ISP and service level at a mediation server;
retrieving a new configuration file for the cable modem from a directory server;
reprovisioning the cable modem with a new configuration file for the chosen ISP; and
assigning the computer a new IP address within a range of addresses for the chosen ISP.

15. The method of claim 14, wherein assigning the cable modem an IP address and a default profile comprises:
requesting configuration information for the cable modem from a provisioning system;
checking if a MAC address of the cable modem is registered with a directory server; and
assigning a default profile and IP address to the cable modem if the MAC address is not registered.

16. The method of claim 15, wherein assigning a default profile comprises:
creating a default cable modem configuration file; and
storing the default configuration file in a mass storage.

17. The method of claim 16, and further comprising:
transferring the default configuration file to the cable modem via TFTP.

18. The method of claim 14, and further comprising:
setting filters in the cable modem to direct any hypertext transfer protocol request to an ISP provisioning site.

19. The method of claim 14, wherein assigning a computer connected to the cable modem a default non-ISP IP address comprises:
directing any http request from the cable modem to an ISP provisioning site.

20. The method of claim 14, wherein assigning a computer connected to the user cable modem a default non-ISP IP address comprises:
sending a DHCP request to a provisioning web site with an assigned IP address of the cable modem;
requesting an ISP assignment of the IP address of the cable modem from a directory server;
selecting a non-ISP IP address not assigned to a specific ISP; and
communicating the non-ISP IP address to the cable modem.

21. The method of claim 14, wherein signing a user up for an ISP comprises:
communicating an assigned user computer IP address to a mediation server;
communicating with a provisioning server to obtain a cable modem MAC address and cable modem IP address corresponding to the user computer IP address;
retrieving a list of ISPs and services available for the cable modem whose MAC address and IP address have been obtained;
subscribing a user to one of the retrieved available ISPs;
creating a new cable modem configuration profile for the subscribed to ISP; and
rebooting the cable modem with the new configuration profile.

22. The method of claim 21, wherein rebooting the cable modem comprises:
issuing an SNMP command to the cable modem to reboot with the new configuration profile.

23. The method of claim 14, wherein reprovisioning the cable modem comprises:
sending a DHCP request to a provisioning server with an ISP specific configuration profile;
retrieving an ISP specific configuration profile from a directory server;
creating a new configuration file at the provisioning server; and
transmitting the new configuration file to the cable modem.

24. The method of claim 23, wherein the new configuration profile is retrieved via TFTP.

25. The method of claim 14, wherein assigning the computer a new IP address comprises:
sending a DHCP request from the user computer through an ISP configured cable modem;
selecting a new IP address within a range of IP addresses of the user ISP; and
transmitting the new IP address to the user computer.

26. A method of operating a mediation server, comprising:
receiving a request for access to an ISP;
determining an IP address of the request;
associating the IP address with an access device MAC address; and
reconfiguring the access device for the ISP.

27. A method of operating a provisioning system, comprising:
assigning an IP address to a new access device;
storing a MAC address of the new access device in a directory server;
providing the MAC address associated with the IP address when requested by an external mediation server; and
creating an access device configuration file for ISP information provided by the mediation server.

28. A provisioning system, comprising:
a dynamic host configuration protocol server;
a trivial file transfer protocol server;
a system log server;
a time of day server; and
a computer program resident and operating on the DHCP server, the program comprising machine readable instructions for causing the DHCP server for performing a method comprising:
assigning an IP address to a new access device;
storing a MAC address of the new access device in a directory server;
providing the MAC address associated with the IP address when requested by an external mediation server; and
creating an access device configuration file for ISP information provided by the mediation server.

29. An automated registration system, comprising:
a directory server;
a mediation server having a first computer program thereon, the first computer program comprising machine readable instructions for causing the mediation server to perform a method comprising:
receiving a request for access to an ISP;
determining an IP address of the request;
associating the IP address with an access device MAC address; and
reconfiguring the access device for the ISP; and
a provisioning server having a DHCP server, a TFTP server, a SYSLOG server, and a time of say server, the provisioning server having a second computer program operating thereon, the second computer program comprising machine readable instructions for causing the provisioning server to execute a method comprising:
assigning an IP address to a new access device;
storing a MAC address of the new access device in the directory server;
providing the MAC address associated with the IP address when requested by the external mediation server; and
creating an access device configuration file for ISP information provided by the mediation server.

30. A provisioning server, comprising:
a DHCP server;
a TFTP server;
a SYSLOG server;
a time of day server; and
a computer program operable in memory of the DHCP server by a processor in the DHCP server, the program comprising machine readable instructions for causing a computer to perform a method, the method comprising:
assigning an IP address to a new access device;
storing a MAC address of the new access device in a directory server;
providing the MAC address associated with the IP address when requested by an external mediation server; and
creating an access device configuration file for ISP information provided by the mediation server.

31. A mediation server, comprising:
a processor;
a main memory;
a mass storage device; and
a computer readable medium stored in the mass storage device and operable in the main memory by the processor, the program comprising machine readable instructions for causing the mediation server to execute a method, the method comprising:
receiving a request for access to an ISP;
determining an IP address of the request;
associating the IP address with an access device MAC address; and
reconfiguring the access device for the ISP.
